(19) United States
(12) Patent Application Publication
(10) Pub. No.: US 2019/0369918 A1
(43) Pub. Date: Dec. 5, 2019

(54) MEMORY SYSTEM AND OPERATING MEHTOD THEREOF

(71) Applicant: SK hynix Inc., Gyeonggi-do (KR)

(72) Inventors: Young-Ick CHO, Seoul (KR); Sung-Kwan HONG, Seoul (KR); Byeong-Gyu PARK, Gyeonggi-do (KR)

(21) Appl. No.: 16/223,878

(22) Filed: Dec. 18, 2018

(30) Foreign Application Priority Data
May 31, 2018 (KR) 10-2018-0062294

(51) Int. Cl. G06F 3/06; G06F 12/0804; G06F 11/10

(52) U.S. Cl. CPC G06F 3/0659; G06F 3/0614; G06F 11/1044; G06F 12/0804; G06F 3/0679

(57) ABSTRACT

An operating method of a memory system may include: allocating target map data to a target slot, among a plurality of slots within a compression engine; compressing the target map data to a set size in the target slot; switching the state of the target slot to a second state, when the compression is completed; generating an interrupt signal and providing the interrupt signal to a processor, when the state of the target slot is switched to the second state; providing a release command for the target slot to the compression engine in response to the interrupt signal; and switching the state of the target slot to the first state in response to the release command.

### CROSS-REFERENCE TO RELATED APPLICATION

The present application claims priority under 35 U.S.C. § 119(a) to Korean Patent Application No. 10-2018-0062294, filed on May 31, 2018, the disclosure of which is incorporated herein by reference in its entirety.

### BACKGROUND

### 1. Field

Various embodiments of the present invention relate to a memory system. Particularly, embodiments relate to a memory system capable of efficiently performing a read operation, and an operating method thereof.

### 2. Description of the Related Art

The computer environment paradigm has moved towards ubiquitous computing, which enables computing systems to be used anytime and anywhere. As a result, the demand for portable electronic devices, such as mobile phones, digital cameras, and laptop computers have increased rapidly. Those electronic devices generally include a memory system using a memory device as a data storage device. The data storage device may be used as a main memory unit or an auxiliary memory unit of a portable electronic device.

Since there is no mechanical driving part, a data storage device using a memory device provides advantages such as excellent stability and durability, high information access speed, and low power consumption. Also, a data storage device can have a quick data access rate with low power consumption relative to a hard disk device. Non-limiting examples of the data storage device having such advantages include universal serial bus (USB) memory devices, memory cards of diverse interfaces, and solid-state drives (SSD).

### SUMMARY

Various embodiments of the present invention are directed to a memory system capable of efficiently processing map data.

In accordance with an embodiment of the present invention, an operating method of a memory system may include: allocating target map data to a target slot, among a plurality of slots within a compression engine, the target slot having a first state when the target map data is allocated thereto; compressing the target map data to a set size in the target slot; switching the state of the target slot to a second state, when the compression is completed; generating, by a compression engine, an interrupt signal and providing the interrupt signal to a processor, when the state of the target slot is switched to the second state; providing, by the processor, a release command for the target slot to the compression engine in response to the interrupt signal; and switching the state of the target slot to the first state in response to the release command.

In accordance with an embodiment of the present invention, a memory system may include: a memory device suitable for storing map data and user data corresponding to the map data; and a controller comprising a compression engine including a plurality of slots and suitable for managing states of the plurality of slots and compressing map data in each of the slots to a set size; and a processor suitable for controlling the memory device, wherein the controller loads target map data from the memory device in response to a request, allocates the target map data to a target slot, among the plurality of slots within the compression engine, the target slot having a first state when the target data is allocated thereto, compresses the target map data to the set size in the target slot, switches the state of the target slot to a second state when the compression is completed, provides an interrupt signal generated through the compression engine to the processor when the state of the target slot is switched to the second state, provides a release command generated through the processor to the compression engine in response to the interrupt signal, and switches the state of the target slot to the first state in response to the release command.

In accordance with an embodiment of the present invention, a memory system may include a memory device suitable for storing map data that includes a plurality of map segments; and a controller suitable for loading the map data from the memory device, wherein the controller comprises: a compression engine including a plurality of slots, each slot configured to selectively represent a first state and a second state; and a processor suitable for issuing a release signal to the compression engine, in response to an interrupt signal from the select slot, to change the state of the select slot from the first state to the second state, wherein the first state represents that a loaded map segment is compressed and the interrupt signal is issued when compression of the loaded map segment is completed; and the second state represents an idle state.

### BRIEF DESCRIPTION OF THE DRAWINGS

The description herein makes reference to the accompanying drawings wherein like reference numerals refer to like parts throughout the several views, and wherein:

FIG. 1 is a block diagram illustrating a data processing system including a memory system in accordance with an embodiment of the present disclosure;

FIG. 2 is a diagram illustrating a memory device of a memory system in accordance with an embodiment of the present disclosure;

FIG. 3 is a circuit diagram illustrating a memory cell array of a memory block in a memory device in accordance with an embodiment of the present disclosure;

FIG. 4 is a diagram illustrating a three-dimensional structure of a memory device in accordance with an embodiment of the present disclosure;

FIG. 5 illustrates a memory system in accordance with an embodiment of the present disclosure;

FIG. 6 illustrates a map table in accordance with an embodiment of the present disclosure;

FIG. 7 illustrates a meta table in accordance with an embodiment of the present disclosure;

FIG. 8A is a block diagram illustrating an operation of a controller in accordance with an embodiment of the present disclosure;

FIG. 8B is a flowchart illustrating an operation process of a controller in accordance with an embodiment of the present disclosure;

FIG. 9A is a flowchart illustrating an operation process of a controller to update a map table and a meta table according to a write request in accordance with an embodiment of the present disclosure;

FIG. 9B is a flowchart illustrating an operation process of a controller which processes a read request provided from a host in accordance with an embodiment of the present disclosure; and

FIGS. 10 to 18 are diagrams illustrating exemplary applications of a data processing system in accordance with various embodiments of the present invention.

### DETAILED DESCRIPTION

Various embodiments of the disclosure are described below in more detail with reference to the accompanying drawings. However, elements and features of the present disclosure may be configured or arranged differently than disclosed herein. Thus, the present invention is not limited to the embodiments set forth herein. Rather, the described embodiments are provided so that this disclosure is thorough and complete and fully conveys the disclosure to those skilled in the art to which this invention pertains. Throughout the disclosure, like reference numerals refer to like parts throughout the various figures and examples of the disclosure. It is noted that reference to “an embodiment,” “another embodiment,” and the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could be termed a second or third element in another instance without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via one or more intervening elements. Communication between two elements, whether directly or indirectly connected/coupled, may be wired or wireless, unless stated or the context indicates otherwise.

In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

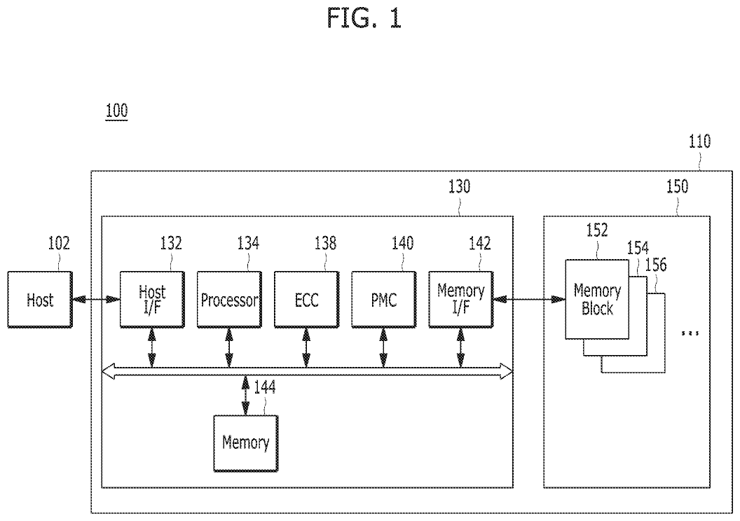

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, a portable electronic device such as a mobile phone, an MP3 player and a laptop computer or an electronic device such as a desktop computer, a game player, a television (TV), a projector, or the like.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) or a static RAM (SRAM) and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) or a flash memory.

The memory system 110 may include a controller 130 and a memory device 150. The memory device 150 may store data to be accessed by the host 102, and the controller 130 may control storage of data in the memory device 150.

The controller 130 and the memory device 150 may be integrated into a single semiconductor device, which may be included in any of the various types of memory systems as exemplified above.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device that retains data stored therein even while electrical power is not supplied. The memory device 150 may store data provided from the host 102 through a write operation, and provide data stored therein to the host 102 through a read operation. The memory device 150 may include a plurality of memory blocks 152 to 156, each of which may include a plurality of pages. Each of the plurality of pages may include a plurality of memory cells to which a plurality of word lines (WL) are electrically coupled.

The controller 130 may control overall operations of the memory device 150, such as read, write, program and erase operations. For example, the controller 130 may control the memory device 150 in response to a request from the host 102. The controller 130 may provide the data, read from the memory device 150, to the host 102, and/or may store the data, provided by the host 102, into the memory device 150.

The controller 130 may include a host interface (I/F) 132, a processor 134, an error correction code (ECC) component 138, a power management unit (PMU) 140, a memory interface (I/F) 142, and a memory 144, all operatively coupled via an internal bus.

The host interface 132 may process commands and data provided from the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE).

The ECC component 138 may detect and correct errors in the data read from the memory device 150 during the read operation. When the number of the error bits is greater than or equal to a threshold number of correctable error bits, the ECC component 138 may not correct error bits but instead may output an error correction fail signal indicating failure in correcting the error bits.

The ECC component 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC component 138 may include any and all circuits, modules, systems or devices for performing the error correction operation based on at least one of the above described codes.

The PMU 140 may provide and manage power of the controller 130.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134, when the memory device 150 is a flash memory and, in particular, a NAND flash memory.

The memory 144 may serve as a working memory of the memory system 110 and the controller 130, and may store temporary or transactional data for operating or driving the memory system 110 and the controller 130. The controller 130 may control the memory device 150 in response to a request from the host 102. The controller 130 may deliver data read from the memory device 150 into the host 102, may store data entered through the host 102 in the memory device 150. The memory 144 may be used to store data required for the controller 130 and the memory device 150 in order to perform these operations.

The memory 144 may be implemented with a volatile memory such as a static random access memory (SRAM) or a dynamic random access memory (DRAM). Although FIG. 1 shows the memory 144 disposed within the controller 130, the disclosure is not limited thereto. That is, the memory 144 may be located externally to the controller 130. For instance, the memory 144 may be embodied by an external volatile memory having a memory interface for transferring data and/or signals transferred between the memory 144 and the controller 130.

The processor 134 may control the overall operations of the memory system 110. The processor 134 may drive or execute a firmware to control the overall operations of the memory system 110. The firmware may be referred to as a flash translation layer (FTL).

An FTL may perform an operation as an interface between the host 102 and the memory device 150. The host 102 may transmit requests for write and read operations to the memory device 150 through the FTL.

The FTL may manage operations of address mapping, garbage collection, wear-leveling and the like. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data on another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134. The management unit may perform bad block management of the memory device 150. The management unit may find bad memory blocks in the memory device 150, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may significantly reduce the utilization efficiency of the memory device 150 having a 3D stack structure and the reliability of the memory system 100, and thus reliable bad block management is required.

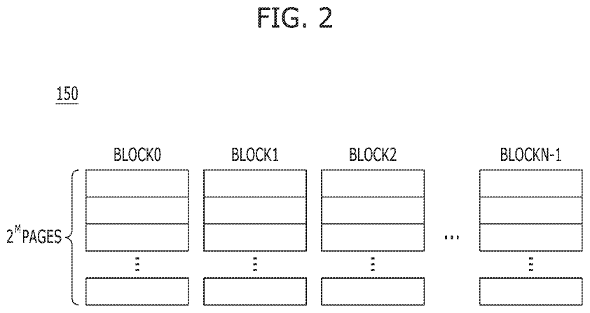

FIG. 2 is a diagram illustrating a memory device in accordance with an embodiment of the present disclosure, for example, the memory device 150 of FIG. 1.

Referring to FIG. 2, the memory device 150 may include the plurality of memory blocks BLOCK 0 to BLOCKN−1, each of which may include a plurality of pages, for example, 2^{M} pages, the number of which may vary according to circuit design. The memory device 150 may include a plurality of memory blocks, such as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

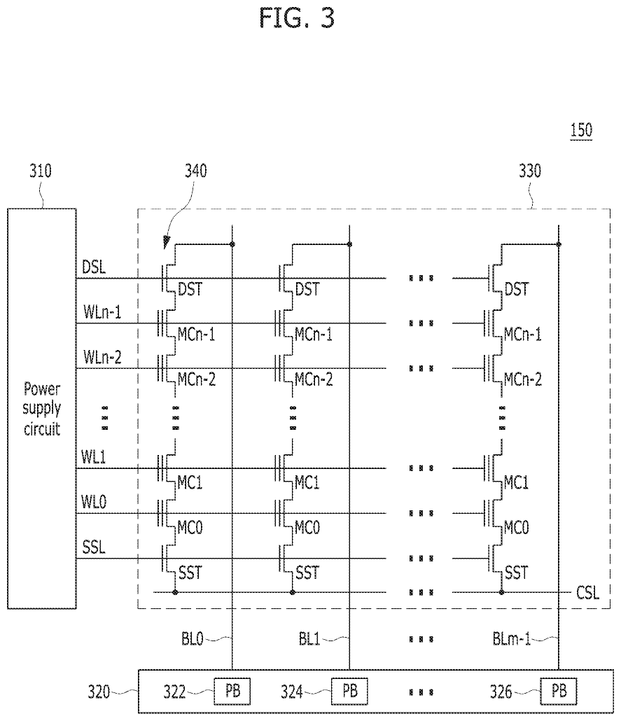

FIG. 3 is a circuit diagram illustrating a memory block in accordance with an embodiment of the present disclosure, for example, a memory block 330 in the memory device 150.

Referring to FIG. 3, the memory block 330 may correspond to any of the plurality of memory blocks 152 to 156 included in the memory device 150 of the memory system 110.

The memory block 330 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured by single level cells (SLC) each of which may store 1 bit of information, or by multi-level cells (MLC) each of which may store data information of a plurality of bits. The strings 340 may be electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, that the memory block 330 is constituted with NAND flash memory cells, it is to be noted that the memory block 330 of the memory device 150 is not limited to a NAND flash memory. The memory block 330 may be realized by a NOR flash memory, a hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A power supply circuit 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The power supply circuit 310 may perform a voltage generating operation under the control of a control circuit (not shown). The power supply circuit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read and write (read/write) circuit 320 of the memory device 150 may be controlled by the control circuit, and may serve as a sense amplifier or a write driver according to an operation mode. During a verification operation or a normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

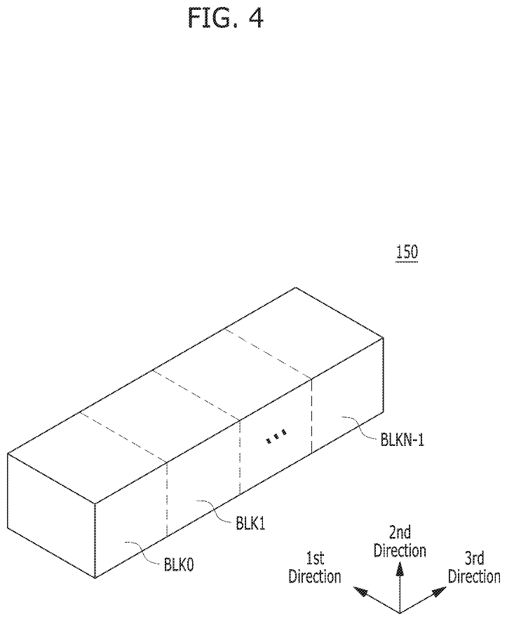

FIG. 4 is a schematic diagram illustrating a three-dimensional (3D) structure of a memory device, e.g., the memory device 150, in accordance with an embodiment of the present disclosure.

Although FIG. 4 shows a 3D structure, the memory device 150 may be embodied by a two-dimensional (2D) memory device. Specifically, as illustrated in FIG. 4, the memory device 150 may be embodied in a nonvolatile memory device having a 3D stack structure. When the memory device 150 has a 3D structure, the memory device 150 may include a plurality of memory blocks BLK0 to BLKN−1 each having a 3D structure (or a vertical structure).

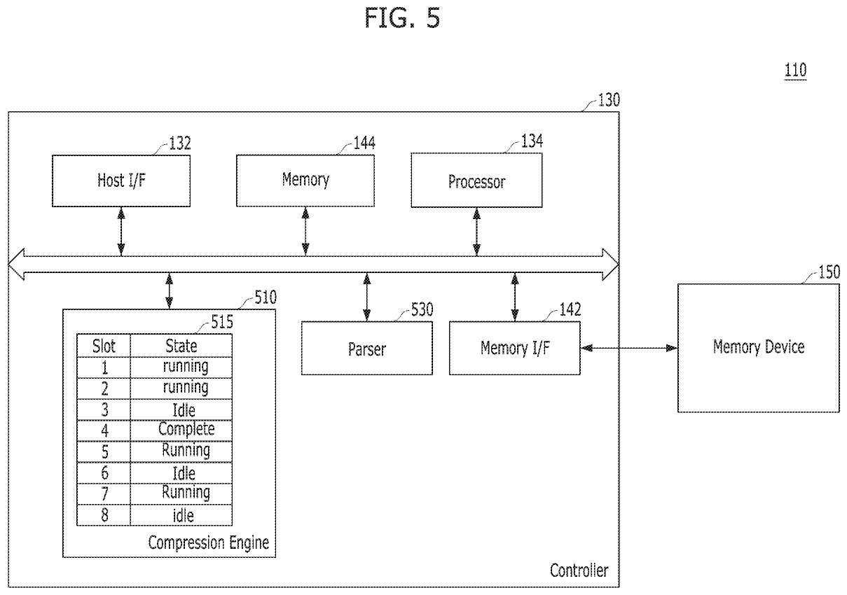

FIG. 5 illustrates a memory system 110 in accordance with an embodiment. In particular, FIG. 5 illustrates the structure of the controller 130. While the controller 130 has been described with reference to FIG. 1, only components for describing the core characteristics of the present embodiment are illustrated in FIG. 5.

Referring to FIG. 5, the memory system 110 may include the controller 130 and the memory device 150. As described with reference to FIGS. 2 to 4, the memory device 150 may have a storage space capable of storing data. The controller 130 may control the memory device 150. For example, the controller 130 may control the memory device 150 to program data thereto or to read data therefrom.

The controller 130 may include the host interface (I/F) 132, the processor 134, the memory interface (I/F) 142 and the memory 144 as illustrated in FIG. 1, and further include a compression engine 510 and a parser 530.

As described above, the processor 134 may process a request received from the host 102. For example, when a read request is received from the host 102, the processor 134 may control the memory device 150 to read data corresponding to the read request from the memory device 150.

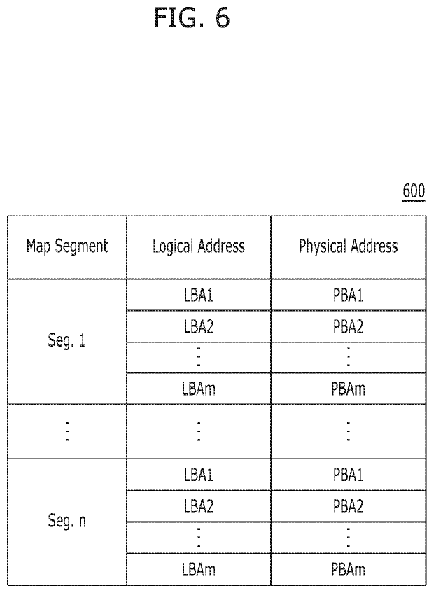

FIG. 6 illustrates a map table 600 in accordance with an embodiment. The map table 600 may be included in the memory system 110 to enable the processor 134 may efficiently read data. Referring to FIG. 6, the map table 600 may store map data. Specifically, the map table 600 may store a plurality of map segments Seg. 1 to Seg. n. Each of the map segments Seg. 1 to Seg. n may include a plurality of logical addresses LBA1 to LBAm and a plurality of physical addresses PBA1 to PBAm, and the plurality of logical addresses LBA1 to LBAm may correspond to the respective physical addresses PBA1 to PBAm. For example, the first logical address LBA1 may correspond to the first physical address PBA1.

Referring again to FIG. 5, the processor 134 may update the map table 600. For example, when a write request for the memory device 150 is provided to the controller 130 from the host 102, the processor 134 may allocate a physical address for storing write data, such that the physical address can correspond to a logical address corresponding to the write request. Then, the processor 134 may update the map table 600 to reflect the allocated physical address.

The processor 134 may store the map table 600 in the memory device 150 according to a request of the host 102 (for example, a flush command). Also, the processor 134 may store the map table 600 in the memory 144. When a read request from the host 102 is provided to the controller 130, the processor 134 may quickly check map data corresponding to the read request based on the map table 600 stored in the memory 144 or the memory device 150, and read data corresponding to the read request based on the checked map data.

However, since the memory 144 is a working memory of the processor 134, the processor 134 can load the data stored in the memory 144 more quickly than the data stored in the memory device 150. That is, the processor 134 may load the map data stored in the memory 144 more quickly than the map data stored in the memory device 150. Therefore, when the map table 600 indicates that a large amount of map data is stored in the memory 144, the read performance of the processor 134 may be improved. However, since the memory 144 has a smaller capacity than the memory device 150, a map table which indicates map data corresponding to all data stored in the memory device 150 cannot be stored in the memory 144. That is, the memory 144 may store only a part of the map table(s) stored in the memory device 150.

The compression engine 510 may read the map data loaded from the memory device 150 by the processor 134, and compress the read data to a set size, which may be predetermined, in order to store a large amount of map data in the memory 144. The compression engine 510 may compress the map data on a map segment basis. However, this is only an example, and the present embodiment is not limited thereto.

The compression engine 510 may include a plurality of slots, and the plurality of slots may separately operate. That is, the compression engine 510 may compress map data in parallel through the respective slots. The map data may represent compressible map data among the map data loaded from the memory device 150. Furthermore, the compression engine 510 may generate and store a state table 515 indicating the states of the plurality of slots. The processor 134 may check the states of the respective slots, based on the state table 515. For example, the processor 134 may check through the state table 515 that the first slot is ‘running’, the third slot is ‘idle’, and the fourth slot is ‘complete’. The running state may indicate that compression is being performed. The idle state may indicate that an operation is not performed. The complete state may indicate that compression has been completed. By way of example, FIG. 5 illustrates that the compression engine 510 includes the state table 515 indicating the states of eight slots. However, this is only an example; the number of slots may be more or less than eight depending on design considerations.

The compression engine 510 may provide meta information to the processor 134 while the map table 600 is updated by the processor 134. The meta information may indicate whether the map data is compressible. For example, when sequential data are included in a target map segment, the compression engine 510 may determine that the target map segment is compressible.

The processor 134 may update a meta table based on the meta information provided from the compression engine 510, such that the meta information is reflected in the meta table so as to correspond to the updated map data. The meta table may be stored in the memory 144.

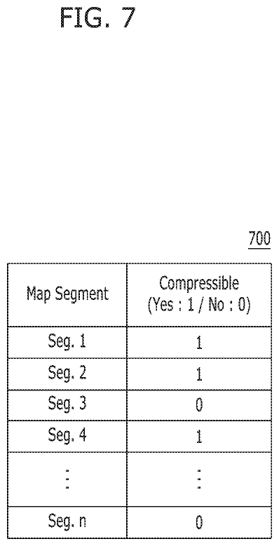

FIG. 7 illustrates a meta table 700 in accordance with an embodiment. FIG. 7 illustrates the meta table 700 indicating whether map segments can be compressed on a map segment basis. However, this is only an example, and the meta table 700 may be designed in various other ways consistent with the teachings herein.

Referring to FIG. 7, the meta table 700 may store meta information corresponding to the plurality of map segments Seg. 1 to Seg. n. That is, the meta table 700 may store information indicating whether the map segments can be compressed. The meta table 700 may include a field for storing map segments, and a field for storing indication information (i.e., indication bits) indicating whether the map segments are compressible. For example, indication information having a logic value ‘1’ may represent that corresponding map segment is compressible while indication information having a logic value ‘0’ may represent that corresponding map segment is incompressible.

Referring again to FIG. 5, the processor 134 may check through the meta table 700 that a first map segment Seg. 1 having a logic value ‘1’ can be compressed, and a third map segment Seg. 3 having a logic value ‘0’ cannot be compressed. The meta table 700 may be updated by the processor 134, and the processor 134 may store the meta table 700 in the memory 144 and the memory device 150.

The processor 134 may allocate map data loaded from the memory device 150 to an idle slot within the compression engine 510, based on the meta table 700. The compression engine 510 may compress the allocated map data to a set size, which may be predetermined, and output the compressed map data. The compressed map data may be stored in the memory 144 by the processor 134.

The parser 530 may parse the map data stored in the memory 144, and check the storage position of data (for example, physical address) corresponding to the map data. The parser 530 may decompress the compressed map data. Therefore, when the compressed map data need to be parsed, the parser 530 may first decompress the compressed map data, and then check the storage position of data corresponding to the map data by parsing the decompressed map data. Furthermore, the processor 134 may control the memory device 150 to read data corresponding to a read request received from the host 102, based on the decompressed map data.

The memory 144 serving as a working memory of the memory system 110 and the controller 130 may temporarily store data which are to be transferred to the memory device 150 from the host 102 or transferred to the host 102 from the memory device 150. Furthermore, the memory 144 may store the map table 600 and the meta table 700 therein.

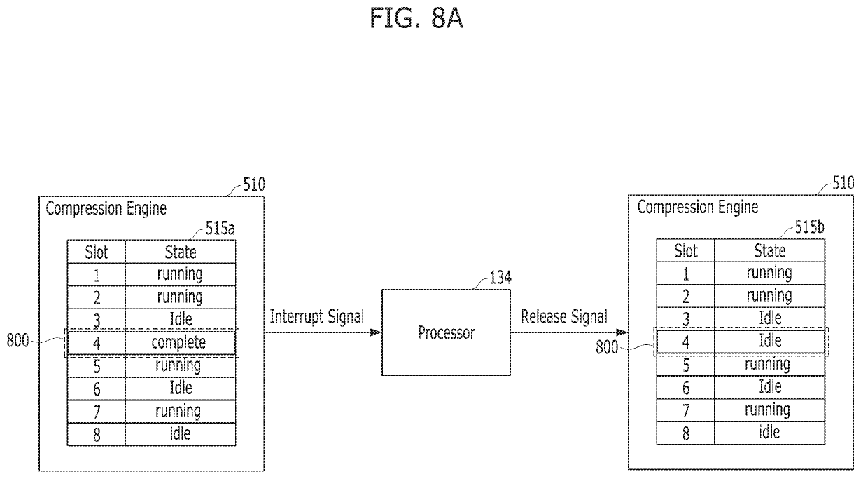

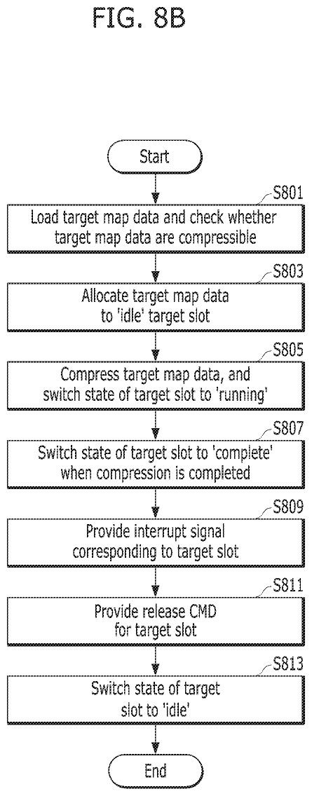

FIG. 8A is a block diagram illustrating an operation of a controller, e.g., the controller 130 of FIG. 5, in accordance with an embodiment. In particular, FIG. 8A illustrates an operation of the controller 130 which processes a slot having a state ‘complete’ within the compression engine 510. The plurality of slots within the compression engine 510 may be separately processed, and not affect one another.

Referring to FIG. 8A, the processor 134 may allocate compressible map data to the respective slots within the compression engine 510. The compression engine 510 may compress the map data allocated to the respective slots. The state of a slot in which compression is being performed may be represented by ‘running’. The state of a slot in which compression is not performed may be represented by ‘idle’. The state of a slot in which compression has been completed may be represented by ‘complete’.

Therefore, the processor 134 may allocate compressible map data to a target slot 800 in the ‘idle’ state. Then, the compression engine 510 may compress the map data, and the state of the target slot 800 to which the map data have been allocated may be changed to the ‘running’ state. Furthermore, the compression engine 510 may update the state table 515. Then, when the map data are completely compressed, the compression engine 510 may change the state of the target slot 800 to the ‘complete’ state. Furthermore, the compression engine 510 may update the state table 515a.

When the slot in which compression has been completed occurs, the compression engine 510 may provide an interrupt signal to the processor 134. That is, the compression engine 510 may provide the interrupt signal to the processor 134, in order to output the completely compressed map data. When receiving the interrupt signal, the processor 134 may provide a release signal or command (CMD) for the target slot 800 to the compression engine 510. The compression engine 510 receiving the release command may switch or change the state of the target slot 800 back to the ‘idle’ state. That is, the target slot 800 may be switched back to a state in which the target slot 800 can receive map data. Furthermore, the compression engine 510 may update the state table 515b. The processor 134 may store the map data compressed in the target slot 800 into the memory 144.

When the target slot is maintained in the complete state for a long time, the compression engine 510 may not have enough slots available to compress map data in parallel. That is, the compression engine 510 needs to rapidly switch the state of the target slot from ‘complete’ to ‘idle’. As described above, the compression engine 510 may reduce the time required for each of the slots to remain in the ‘complete’ state, using the interrupt signal. As a result, it is possible to shorten the time required for loading the compressed map data from the processor 134 to the memory 144.

FIG. 8B is a flowchart illustrating an operation process of a controller, e.g., the controller 130 of FIG. 5, in accordance with an embodiment. In particular, FIG. 8B illustrates the operation process of the compression engine 510 and the processor 134, which has been described with reference to FIG. 8A. By way of example, FIG. 8B is based on the supposition that target map data are compressible data.

Referring to FIG. 8B, at step S801, the processor 134 may load target map data from the memory device 150, and check whether the target map data are compressible, based on the meta table 700.

At step S803, the processor 134 may allocate the target map data to an idle target slot within the compression engine 510.

At step S805, the compression engine 510 may compress the target map data. The compression engine 510 may switch or change the state of the target slot to which the target map data have been allocated to ‘running’.

At step S807, when the target map data are completely compressed, the compression engine 510 may switch or change the state of the target slot to ‘complete’.

At step S809, the compression engine 510 may provide an interrupt signal to the processor 134.

At step S811, the processor 134 may provide a release command for the target slot to the compression engine 510 in response to the interrupt signal.

At step S813, the compression engine 510 may switch or change the state of the target slot back to ‘idle’ according to the release command.

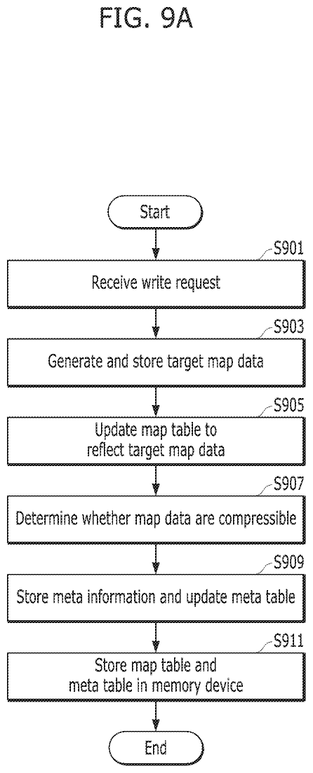

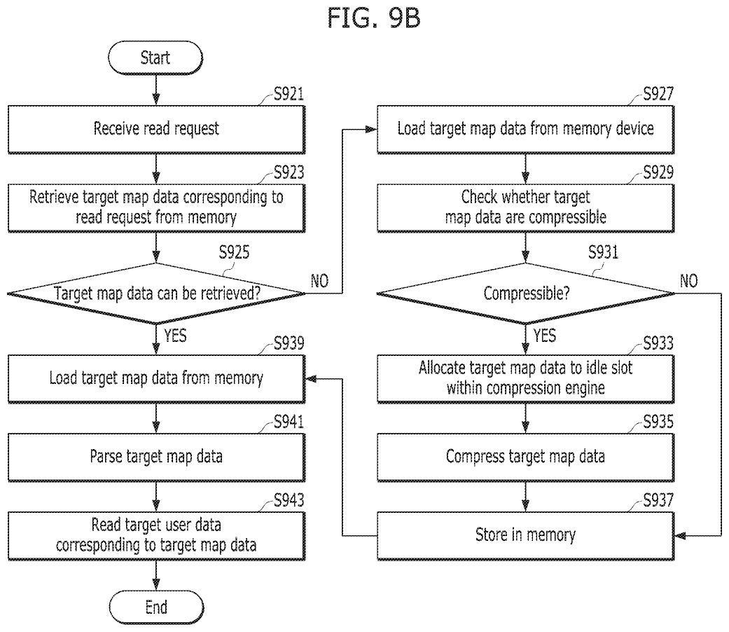

FIGS. 9A and 9B are flowcharts illustrating an operation process of a controller, e.g., the controller 130 of FIG. 5, in accordance with an embodiment. While the operation process of the memory system 110 in accordance with the present embodiment is described with reference to FIGS. 9A and 9B, FIGS. 5 to 8B may be referred to.

FIG. 9A is a flowchart illustrating an operation process of the controller 130 to update the map table 600 and the meta table 700 according to a write request.

Referring to FIG. 9A, at step S901, the controller 130 may receive the write request from the host 102.

At step S903, the processor 134 may allocate a physical address for storing write data, such that the physical address corresponds to a logical address corresponding to the write request. The processor 134 may store map data corresponding to the write request in the memory 144.

At step S905, the processor 134 may update the map table 600 in order to reflect the map data stored in the memory 144.

At step S907, the compression engine 510 may determine whether the map data received from the processor 134 are compressible, and provide meta information based on that determination to the processor 134. The meta information may indicate whether the map data are compressible.

At step S909, the processor 134 may store the meta information in the memory 144, and update the meta table 700 stored in the memory 144 by reflecting the received meta information, such that the meta table 700 corresponds to the map data corresponding to the write request.

At step S911, the processor 134 may store the map data, the meta information, the map table 600 and the meta table 700 in the memory device 150 according to a request of the host 102 (for example, a flush command). The map table 600 and the meta table 700 may include the map data and the meta information reflected therein.

FIG. 9B is a flowchart illustrating an operation process of a controller, e.g., the controller 130, which processes a read request provided from the host 102 in accordance with an embodiment.

Referring to FIG. 9B, at step S921, the controller 130 may receive a read request from the host 102.

At step S923, the processor 134 may retrieve target map data corresponding to the read request from the memory 144. That is, the processor 134 may check whether the target map data are cached in the memory 144.

When it is determined that the processor 134 cannot retrieve the target map data from the memory 144 (No at step S925), that is, the target map data are not cached in the memory 144, the processor 134 may load the target map data from the memory device 150 at step S927.

At step S929, the processor 134 may check whether the target map data are compressible, using the meta table 700. That is, the processor 134 may check meta information corresponding to the target map data.

When it is determined that the target map data are compressible data (Yes at step S931), the processor 134 may allocate the target map data to an idle slot among the plurality of slots within the compression engine 510 at step S933.

At step S935, the compression engine 510 may compress the target map data. The slot in which compression has been completed was described with reference to FIG. 8B.

At step S937, the processor 134 may store the compressed target map data in the memory 144.

When it is determined that the target map data are not compressible data (No at step S931), the processor 134 may not provide the target map data to the compression engine 510, but instead may immediately store the target map data in the memory 144 at step S937.

At step S939, the processor 134 may load the compressed target map data. Then, the processor 134 may provide the loaded compressed target map data to the parser 530.

At step S941, the parser 530 may parse the compressed target map data. The parser 530 may decompress the compressed target map data. The parser 530 may provide the decompressed target map data to the processor 134. As a result, the processor 134 may check a physical address in which read data corresponding to the read request are stored.

At step S943, the processor 134 may read target data corresponding to the target map data from the memory device 150. Furthermore, the controller 130 may output the read target data to the host 102.

When it is determined that the processor 134 can retrieve the target map data from the memory 144 (Yes at step S925), that is, the target map data are cached in the memory 144, the processor 134 may load the target map data at step S939. Then, the processor 134 may provide the loaded target map data to the parser 530.

At step S941, the parser 530 may parse the target map data. Then, the parser 530 may provide the parsed target map data to the processor 134. As a result, the processor 134 may check a physical address in which read data corresponding to the read request are stored.

At step S943, the processor 134 may read target data corresponding to the target map data from the memory device 150. Furthermore, the controller 130 may output the read target data to the host 102.

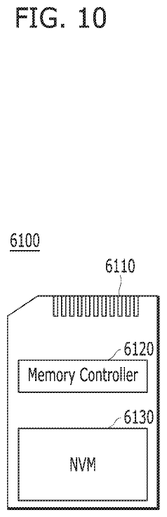

A data processing system and electronic devices which may be constituted with the memory system 110 including the memory device 150 and the controller 130, which are described above by referring to FIGS. 1 to 9B, are described in detail with reference to FIGS. 10 to 18.

FIGS. 10 to 18 are diagrams illustrating exemplary applications of the data processing system of FIGS. 1 to 9B according to various embodiments.

FIG. 10 is a diagram schematically illustrating, as an example of the data processing system, a memory card system 6100 including the memory system in accordance with an embodiment.

Referring to FIG. 10, the memory card system 6100 may include a memory controller 6120, a memory device 6130 and a connector 6110.

More specifically, the memory controller 6120 may be connected to the memory device 6130, and may be configured to access the memory device 6130. The memory device 6130 may be embodied by a nonvolatile memory (NVM). By the way of example but not limitation, the memory controller 6120 may be configured to control read, write, erase and background operations onto the memory device 6130. The memory controller 6120 may be configured to provide an interface between the memory device 6130 and a host (not shown) and/or a drive firmware for controlling the memory device 6130. That is, the memory controller 6120 may correspond to the controller 130 in the memory system 110 described with reference to FIGS. 1 to 9B, while the memory device 6130 may correspond to the memory device 150 described with reference to FIGS. 1 to 9B.

Thus, as shown in FIG. 1, the memory controller 6120 may include a random access memory (RAM), a processor, a host interface, a memory interface and an error correction component. The memory controller 130 may further include other elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system may be applied to wired and/or wireless electronic devices, particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may be so integrated to form a solid state drive (SSD). Also, the memory controller 6120 and the memory device 6130 may form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), a secured digital (SD) card (e.g., SD, miniSD, microSD and SDHC) and/or a universal flash storage (UFS).

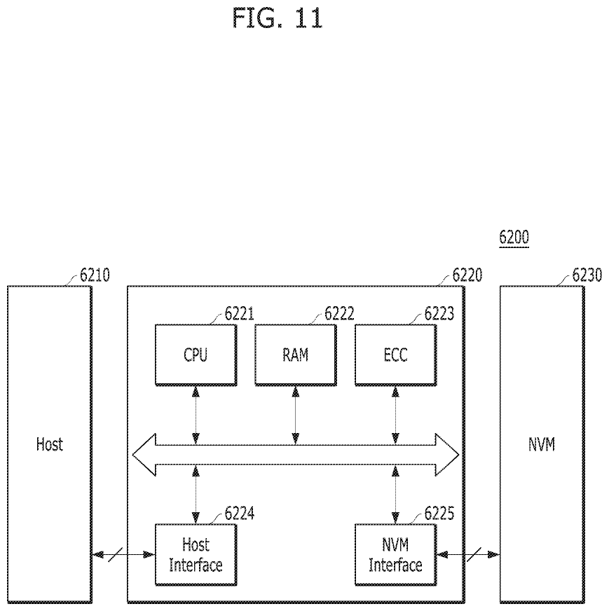

FIG. 11 is a diagram schematically illustrating another example of a data processing system 6200 including a memory system in accordance with an embodiment.

Referring to FIG. 11, the data processing system 6200 may include a memory device 6230 having one or more nonvolatile memories (NVMs) and a memory controller 6220 for controlling the memory device 6230. The data processing system 6200 may serve as a storage medium such as a memory card (e.g., CF, SD, micro-SD or the like) or USB device, as described with reference to FIG. 1. The memory device 6230 may correspond to the memory device 150 in the memory system 110 described in FIGS. 1 to 9B, and the memory controller 6220 may correspond to the controller 130 in the memory system 110 described in FIGS. 1 to 9B.

The memory controller 6220 may control a read, write, or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a failed bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. in this case, the ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit to, and/or receive from, the host 6210 data or signals through the host interface 6224, and may transmit to, and/or receive from, the memory device 6230 data or signals through the NVM interface 6225. The host interface 6224 may be connected to the host 6210 through a parallel advanced technology attachment (PATA) bus, a serial advanced technology attachment (SATA) bus, a small computer system interface (SCSI), a universal serial bus (USB), a peripheral component interconnect-express (PCIe), or a NAND interface. The memory controller 6220 may have a wireless communication function with a mobile communication protocol such as wireless fidelity (WiFi) or Long Term Evolution (LTE). The memory controller 6220 may be connected to an external device, e.g., the host 6210, or another external device, and then transmit and/or receive data to and/or from the external device. As the memory controller 6220 is configured to communicate with the external device through one or more of various communication protocols, the memory system and the data processing system may be applied to wired and/or wireless electronic devices, particularly a mobile electronic device.

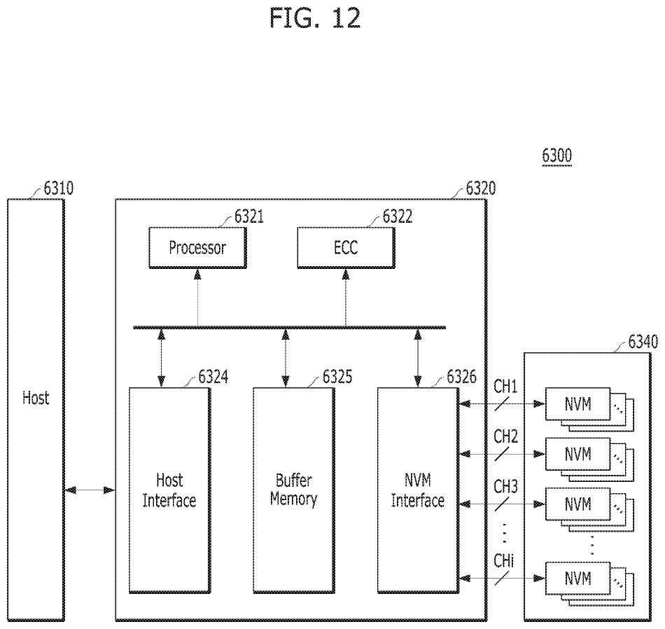

FIG. 12 is a diagram schematically illustrating another example of the data processing system including the memory system in accordance with an embodiment. FIG. 12 schematically illustrates a solid state drive (SSD) to which the memory system may be applied.

Referring to FIG. 12, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). By way of example, FIG. 12 illustrates that the buffer memory 6325 is disposed in the controller 6320, but the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, i.e., RAID level information of the write command provided from the host 6310 in the SSDs 6300, and may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

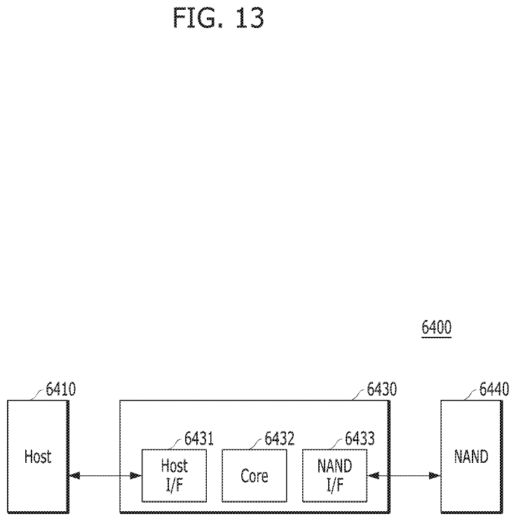

FIG. 13 is a diagram schematically illustrating another example of the data processing system including the memory system in accordance with an embodiment. FIG. 13 schematically illustrates an embedded Multi-Media Card (eMMC) 6400 to which the memory system may be applied.

Referring to FIG. 13, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control the operations of the eMMC 6400, the host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I or UHS-II interface.

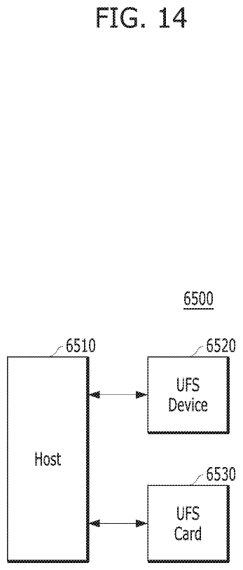

FIGS. 14 to 17 are diagrams schematically illustrating other examples of the data processing system including the memory system in accordance with embodiments. FIGS. 14 to 17 schematically illustrate universal flash storage (UFS) systems to which the memory system may be applied.

Referring to FIGS. 14 to 17, the UFS systems 6500, 6600, 6700 and 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired and/or wireless electronic devices or particularly mobile electronic devices, the UFS devices 6520, 6620, 6720, 6820 may serve as embedded UFS devices. The UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700 and 6800 may communicate with external devices, e.g., wired and/or wireless electronic devices, particularly mobile electronic devices through UFS protocols. The UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 11 to 13, and the UFS cards 6530, 6630, 6730, 6830 may be embodied in the form of the memory card system 6100 described with reference to FIG. 10.

Furthermore, in the UFS systems 6500, 6600, 6700 and 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY or MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through any of various protocols other than the UFS protocol, e.g., universal storage bus (USB) Flash Drives (UFDs), multi-media card (MMC), secure digital (SD), mini-SD, and micro-SD.

In the UFS system 6500 illustrated in FIG. 14, each of the host 6510, the UFS device 6520 and the UFS card 6530 may include UniPro. The host 6510 may perform a switching operation to communicate with at least one of the UFS device 6520 and the UFS card 6530. The host 6510 may communicate with the UFS device 6520 or the UFS card 6530 through link layer switching, e.g., L3 switching at the UniPro. In this case, the UFS device 6520 and the UFS card 6530 may communicate with each other through a link layer switching at the UniPro of the host 6510. In FIG. 14, the configuration in which one UFS device 6520 and one UFS card 6530 are connected to the host 6510 is illustrated for clarity. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520. A star form means an arrangement in which a single device is coupled with plural other devices or cards for centralized control.

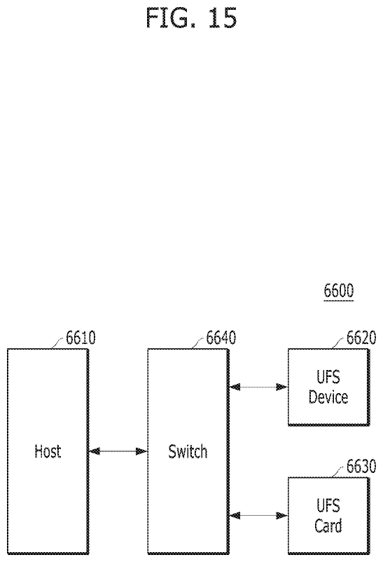

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In FIG. 15, the configuration in which one UFS device 6620 and one UFS card 6630 are connected to the switching module 6640 is illustrated for clarity. However, a plurality of UFS devices and UFS cards may be connected in parallel or in the form of a star to the switching module 6640, and a plurality of UFS cards may be connected in series or in the form of a chain to the UFS device 6620.

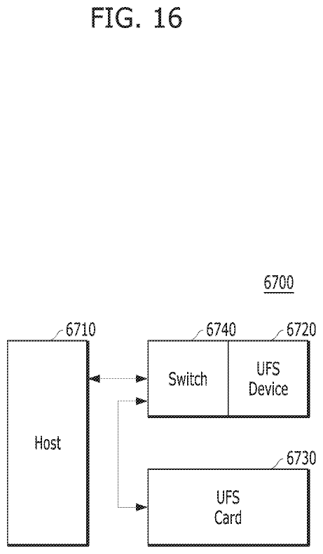

In the UFS system 6700 illustrated in FIG. 16, each of the host 6710, the UFS device 6720 and the UFS card 6730 may include UniPro. The host 6710 may communicate with the UFS device 6720 or the UFS card 6730 through a switching module 6740 performing a switching operation, for example, the switching module 6740 which performs link layer switching at the UniPro, for example, L3 switching. In this case, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In FIG. 16, the configuration in which one UFS device 6720 and one UFS card 6730 are connected to the switching module 6740 is illustrated for clarity. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

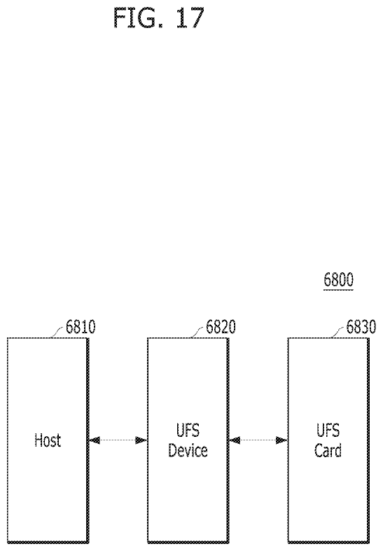

In the UFS system 6800 illustrated in FIG. 17, each of the host 6810, the UFS device 6820 and the UFS card 6830 may include M-PHY and UniPro. The UFS device 6820 may perform a switching operation to communicate with the host 6810 and the UFS card 6830. The UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. Here, the host 6810 and the UFS card 6830 may communicate with each other through target ID switching between the M-PHY and UniPro modules of the UFS device 6820. In FIG. 17, the configuration in which one UFS device 6820 is connected to the host 6810 and one UFS card 6830 is connected to the UFS device 6820 is illustrated for clarity. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

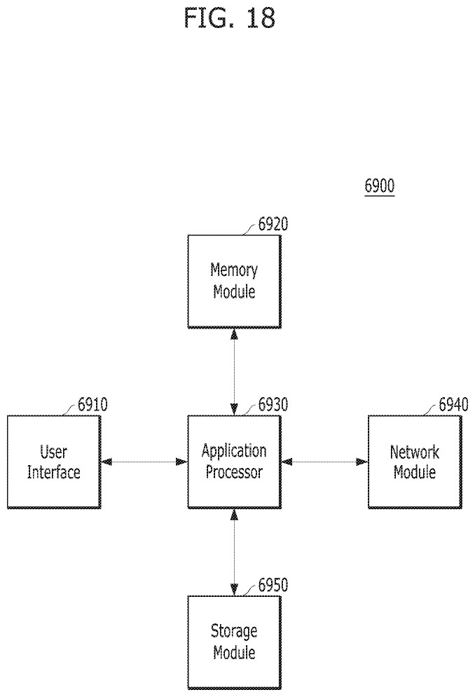

FIG. 18 is a diagram schematically illustrating another example of the data processing system including the memory system in accordance with an embodiment. FIG. 18 is a diagram schematically illustrating a user system 6900 to which the memory system may be applied.

Referring to FIG. 18, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM or LPDDR3 SDRAM, or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired and/or wireless communication with an external device. The user interface 6910 may display data processed by the processor 6930 on a display and touch module of the mobile electronic device, or support a function of receiving data from the touch panel.

While the present invention has been illustrated and described with respect to specific embodiments, it will be apparent to those skilled in the art in light of the present disclosure that various changes and modifications may be made without departing from the spirit and scope of the invention as determined in the following claims.

What is claimed is:

1. An operating method of a memory system, comprising:
allocating target map data to a target slot, among a plurality of slots within a compression engine, the target slot having a first state when the target map data is allocated thereto;
compressing the target map data to a set size in the target slot;
switching the state of the target slot to a second state, when the compression is completed;
generating, by a compression engine, an interrupt signal and providing the interrupt signal to a processor, when the state of the target slot is switched to the second state;
providing, by the processor, a release command for the target slot to the compression engine in response to the interrupt signal; and
switching the state of the target slot to the first state in response to the release command.

2. The operating method of claim 1, further comprising switching the state of the target slot to a third state while the target map data are compressed to the set size.

3. The operating method of claim 1, further comprising:
performing one of:
retrieving the target map data from a memory; and
loading the target map data from a memory device when the target map data are not retrieved from the memory.

4. The operating method of claim 1, wherein the compressing of the target map data comprises compressing the target map data on a map segment basis.

5. The operating method of claim 1, further comprising:
generating a meta table in which meta information, indicating whether respective map data are compressible, is written; and
storing the generated meta table.

6. The operating method of claim 5, wherein the allocating of the target map data to the target slot comprises allocating the target map data to the target slot only when the target map data are compressible based on the meta information in the meta table.

7. The operating method of claim 5, wherein the meta table includes meta information indicating whether the map data are compressible on a map segment basis.

8. The operating method of claim 1, further comprising storing the compressed target map data in a memory.

9. The operating method of claim 8, further comprising:
loading the compressed target map data from the memory; and
parsing the compressed target map data.

10. The operating method of claim 9, further comprising:
reading target user data corresponding to the parsed target map data from the memory device; and
outputting the read target user data.

11. A memory system comprising:
a memory device suitable for storing map data and user data corresponding to the map data; and
a controller comprising a compression engine including a plurality of slots and suitable for managing states of the plurality of slots and compressing map data in each of the slots to a set size; and a processor suitable for controlling the memory device,
wherein the controller loads target map data from the memory device in response to a request, allocates the target map data to a target slot, among the plurality of slots within the compression engine, the target slot having a first state when the target data is allocated thereto, compresses the target map data to the set size in the target slot, switches the state of the target slot to a second state when the compression is completed, provides an interrupt signal generated through the compression engine to the processor when the state of the target slot is switched to the second state, provides a release command generated through the processor to the compression engine in response to the interrupt signal, and switches the state of the target slot to the first state in response to the release command.

12. The memory system of claim 11, wherein the compression engine switches the state of the target slot to a third state while compressing the target map data to the set size.

13. The memory system of claim 11, wherein the controller further comprises a memory suitable for storing the map data,
wherein the processor is configured to retrieve the target map data from the memory, and load the target map data from the memory device when the target map data are not retrieved from the memory.

14. The memory system of claim 11, wherein the compression engine compresses the target map data on a map segment basis.

15. The memory system of claim 11, wherein the processor generates a meta table in which meta information, indicating whether respective map data are compressible, is written, and stores the generated meta table.

16. The memory system of claim 15, wherein the processor allocates the target map data to the target slot only when the target map data are compressible based on the meta information in the meta table.

17. The memory system of claim 15, wherein the meta table includes the meta information indicating whether the map data are compressible on a map segment basis.

18. The memory system of claim 13, wherein the processor stores the compressed target map data in the memory.

19. The memory system of claim 18, wherein the controller further comprises a parser suitable for parsing the map data,
wherein the parser parses the compressed target map data loaded from the memory by the processor.

20. The memory system of claim 19, wherein the controller reads target user data corresponding to the parsed target map data from the memory device, and outputs the read target user data.
